(19) United States
(12) Patent Application Publication
(10) Pub. No.: US 2010/0185843 A1
(43) Pub. Date: Jul. 22, 2010

(54) HARDWARE ENCRYPTING STORAGE DEVICE WITH PHYSICALLY SEPARABLE KEY STORAGE DEVICE

(75) Inventors: Sompong Paul Olarig, Pleasanton, CA (US); Vladimir Sadovsky, Redmond, WA (US); Chris Lionetti, Duvall, WA (US); James Robert Hamilton, Bellevue, WA (US); Harry Raymond Rogers, Bellevue, WA (US); Timothy Louis Falk, Shoreline, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/356,326

(22) Filed: Jan. 20, 2009

(51) Int. Cl. H04L 9/32; G06F 15/177; G06F 21/24

(52) U.S. Cl. 713/2; 713/173

(57) ABSTRACT

Storage devices can provide for hardware encryption and decryption of data stored by them. The hardware cryptographic functions can be applied with reference to cryptographic information of a communicationally, and physically, separable key device. Disconnection of the separable key device can render encrypted data inaccessible. Destruction of the separable key device can result in virtual destruction of the encrypted data. The cryptographic information on the separable key device can be provided by a storage device manufacturer, or by a provisioning computing device. The separable key device can be directly communicationally coupled to a provisioning computing device or it can establish a secure communication tunnel with the provisioning device through a computing device to which the separable key device is communicationally coupled. Cryptographic information can be provided by, and deleted from, the provisioning computing device prior to completion of the booting of that device.

### BACKGROUND

Increasingly, computing devices are being utilized to operate on, and store, data and information that is meant to be kept private. Such data and information can include governmental secrets, but more likely includes business and personal information that could be damaging to one or more individuals if such information was obtained by a malicious party or an adversarial party. As such, various security mechanisms have been implemented, both in association with the hardware of a computing device and in association with the software of a computing device. Examples of such hardware security mechanisms include peripherals designed to generate secure passwords based on biometric information, such as a fingerprint, and physical access barriers to a computing device, such as keyboard locks, communication port locks, and the like. Examples of security mechanisms associated with the software of a computing device include various encryption technologies and various access control technologies.

The protection of data stored on one or more computer-readable media often fails during activity that is not directly associated with a computing device at all. For example, the data stored on one or more computer-readable media can be, and has been, compromised when physical shipments of the computer-readable media have not been properly safeguarded and have, consequently, been lost or even stolen. Similarly, data stored on one or more computer-readable media can be, and has been, compromised when the storage device comprising the computer-readable media has been deemed to have failed and is, therefore, discarded. Often such “failed” storage devices retain a significantly high percentage of the data stored on their computer-readable media in a form that can be retrieved and accessed by a computing device.

To enhance the protection of data stored on computer-readable media, especially if such media were to become physically accessible to malicious or adversarial parties, “full volume” encryption methodologies were developed, whereby substantially all of the data stored on the computer-readable media is stored in an encrypted form such that, even if a malicious or adversarial party were to gain physical control of such media, they would be unlikely to decrypt the data absent an appropriate decryption key. To provide greater performance, the encryption of data being stored on one or more computer-readable media that are part of a storage device, can be performed by dedicated cryptographic hardware that is part of the storage device itself, rather than by burdening the one or more central processing units of the computing device storing and retrieving such data. In addition to full-volume encryption methodologies, the physical destruction, in an appropriate manner, of the computer-readable media on which sensitive data was stored can likewise enhance the protection and security of such data. For example, computer-readable storage media that may have stored data that is to be protected can be physically shredded or exposed to random, strong, magnetic fields, such that the data is either not physically consistent, or is not physically recoverable from the computer-readable media. Unfortunately, such physical destruction of computer-readable media can be both costly and time-consuming and, as efficiencies are sought to reduce the time and expense, short-cuts that may compromise the data stored on such media may be employed, thereby undermining the physical destruction efforts. Additionally, various regulations, such as governmental security regulations, or privacy regulations, can impose additional burdens, such as the requirement that proper destruction of computer-readable storage media is both undertaken and documented in a particular manner.

### SUMMARY

A storage device comprising a hardware cryptographic system can be associated with a physical entity, referred to herein as a “key device”, that can be physically and communicationally separated from the rest of the storage device. The key device can contain cryptographic information that can be utilized by the hardware cryptographic system to, either directly or indirectly, encrypt and decrypt data that is stored on the computer-readable media of the storage device. When the key device is communicationally separated from the hardware cryptographic system, such as by physically separating the key device from the storage device, the encrypted data stored on the computer-readable media of the storage device cannot be decrypted and is, therefore, secure against unauthorized access.

In one embodiment, a storage system can comprise a key device and a storage device that are physically and communicationally separable from one another. The storage device can comprise a hardware cryptographic system that can encrypt and decrypt data stored by the storage device and one or more computer-readable media that can store the encrypted data, and the key device can comprise cryptographic information that can be utilized by the hardware cryptographic system in encrypting and decrypting the data. The communicational separation of the key device from the hardware cryptographic system, such as by physically separating the key device from the storage device, can render inaccessible the encrypted data on the storage media of the storage device, at least until the same key device is communicationally reunited with the hardware cryptographic system. The cryptographic information of the separable key device can be provided by a manufacturer or by the hardware cryptographic system itself, such as during an initialization of the storage device.

In another embodiment, the physically and communicationally separable key device can be independently communicationally connected to a provisioning computing device which can act as a device that manages the cryptographic information that can be provided to one or more key devices. Once communicationally connected to such a provisioning computing device, the key device can receive at least a portion of its cryptographic information from the provisioning computing device. The key device can then be connected to the storage device, thereby enabling the storage device to encrypt and decrypt data with reference to cryptographic information provided, at least in part, by the provisioning computing device.

In an additional embodiment, cryptographic information from the provisioning computing device can be provided by mechanisms that provide the cryptographic information to the key device prior to the completion of the booting process of the provisioning computing device, or by mechanisms, such as a dedicated RAID controller, that can provide the cryptographic information without exposing it to potentially malicious instructions that can execute on the provisioning computing device after it has completed booting.

In a further embodiment, the key device can be physically connected to a storage device that is, in turn, connected to a computing device. The key device can establish a secure communications tunnel with a provisioning computing device, such as by utilizing the network connection, or other communicational capability, of the computing device to which the storage device is connected. The provisioning computing device can then provide, to the key device, cryptographic information through the secure communications tunnel.

In a still further embodiment, the hardware cryptographic system of the storage device can utilize, not only the cryptographic information provided by a key device, but also cryptographic information provided by a computing device that is utilizing the storage device to store data. The data stored on the computer-readable media of the storage device can then be protected by a combination of such cryptographic information.

In a yet further embodiment, if a different key device is communicationally connected to the hardware cryptographic system, the encrypted data, stored on the computer-readable media of the storage device, that was encrypted by reference to cryptographic information received from a prior key device can now be marked as “free space” or as otherwise no longer usable data and can, in such a manner, be considered to have been securely erased. If no key device is communicationally connected to the hardware cryptographic system, and no key device has previously been communicationally connected to it either, then the hardware cryptographic system can report that the storage device is “not ready”, or it can generate internal cryptographic information that it can utilize to encrypt and decrypt data without reference to a key device. The behavior of the storage device in such a case can be user selectable.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary computing device and an exemplary storage system comprising a storage device and a separable key device;

FIG. 2 is a block diagram of an exemplary operation of a storage system comprising a storage device and a separable key device;

FIG. 3 is a block diagram of another exemplary operation of a storage system comprising a storage device and a separable key device;

FIG. 4 is a block diagram of an exemplary operation of a storage system comprising a storage device and a separable key device in combination with a provisioning computing device;

FIG. 5 is a block diagram of another exemplary operation of a storage system comprising a storage device and a separable key device in combination with a provisioning computing device;

FIG. 6 is a block diagram of exemplary cryptographic options implementable by a storage device capable of hardware encryption of data stored thereon;

FIG. 7 is a flow diagram of an exemplary operation of a storage system comprising a storage device and a separable key device; and

FIG. 8 is a flow diagram of an exemplary establishment of a secure communications tunnel by a key device.

### DETAILED DESCRIPTION

The following description relates to storage systems that comprise a storage device and a physically and communicationally separable key device, where the storage device comprises a hardware cryptographic system that can encrypt and decrypt data stored on the storage media of the storage device, and the key device comprises cryptographic information utilized by the hardware cryptographic system. By separating the key device from the storage device, the cryptographic information no longer becomes accessible by the hardware cryptographic system and any data, stored on the storage media of the storage device, that was encrypted with reference to the cryptographic information on such separated key device, becomes unreadable. Consequently, data security, and secure data destruction, can be achieved by simply severing a communicational connection between a key device and a storage device, such as, for example, by physically removing the key device from the storage device. The cryptographic information stored on the key device can be provided by a manufacturer of the storage device, or it can be provided by a provisioning computing device, such as via a communicational connection to the key device independent of any communicational connections to the storage device itself. Such an independent communication connection to the key device can include a secure communications tunnel that can be established between a provisioning computing device and a key device.

The techniques described herein focus on, but are not limited to, a storage device and a physically and communicationally separable key device. Indeed, the below described mechanisms can be equally implemented by physically separate components, including, for example, by a stand-alone cryptographic component that can be communicationally coupled to various storage media, but does not itself serve as a traditional storage device. Consequently, while the descriptions below make reference to a single storage device having the below-described elements, the scope of the descriptions themselves is not intended to be so limited.

Additionally, although not required, the descriptions below will be in the general context of computer-executable instructions, such as program modules, being executed by one or more processing units. More specifically, the descriptions will reference acts and symbolic representations of operations that are performed by one or more processing units, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the processing units or peripherals connected thereto in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the processing units referenced need not be limited to conventional personal computing processing units, and include other processor configurations, including dedicated processors, specific-use processors, communications processors, bus processors and the like often found in hand-held devices, multi-processor systems, microprocessor based or programmable consumer electronics. Similarly, the computing devices referenced in the below descriptions need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

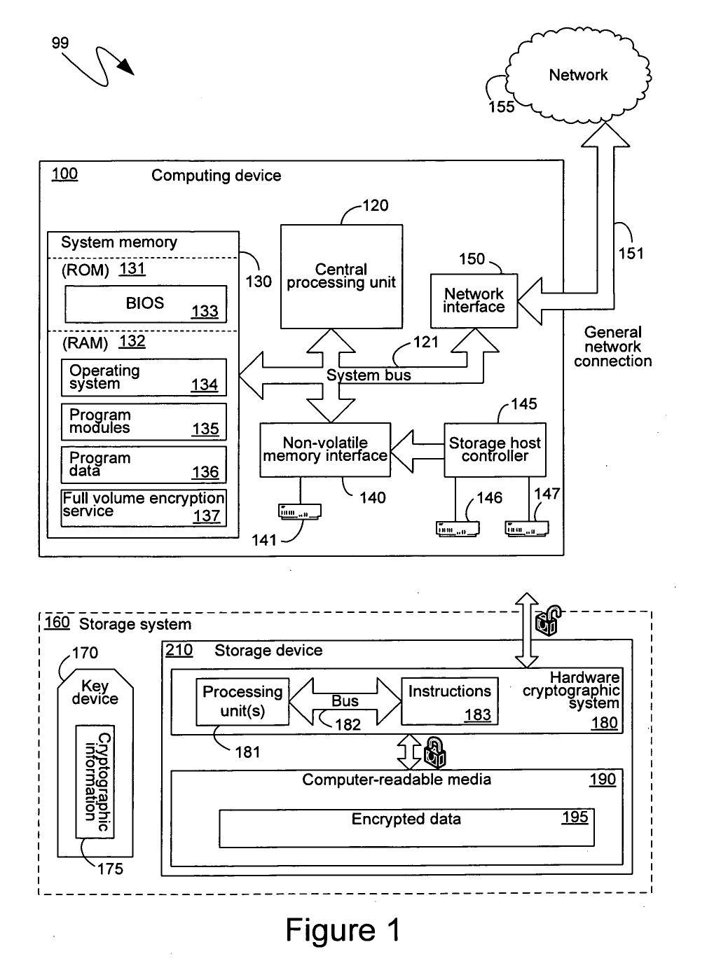

Turning to FIG. 1, an exemplary system 99 comprising an exemplary computing device 100 and an exemplary storage system 160 is illustrated. The storage system 160 can be utilized by the computing device 100 to store data and information provided by the computing device, and the storage system 160 can be utilized as any one of the storage devices 141, 146 and 147, that are shown connected to specific components of the computing device 100.

Turning first to the computing device 100, it can include, but is not limited to, one or more central processing units (CPUs) 120, a system memory 130 and a system bus 121 that couples various system components including the system memory 130 to the processing unit 120. The system bus 121 may be any of several types of bus structures including a memory bus or memory controller, a peripheral bus, and a local bus using any of a variety of bus architectures. Depending on the specific physical implementation, one or more of the CPUs 120 and the system memory 130 can be physically co-located, such as on a single chip. In such a case, some or all of the system bus 121 can be nothing more than silicon pathways within a single chip structure and its illustration in FIG. 1 can be strictly notational convenience for the purpose of illustration.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 1 illustrates an operating system 134, other program modules 135, and program data 136. Also illustrated is a full volume encryption service 137 which can, in some embodiments, be part of the operating system 134. The full volume encryption service 137 can enable the computing device 100 to encrypt substantially, or all, of the information it stores on one or more computer-readable media, or on portions thereof, such as portions defined as individual volumes by the operating system 134 or other storage controller of the computing device.

The computing device 100 may also include other removable/non-removable, volatile/nonvolatile computer storage devices. For example, FIG. 1 illustrates hard disk storage devices 141, 146 and 147 that read from or write to non-removable, nonvolatile magnetic media. Other removable/non-removable, volatile/nonvolatile computer storage media that can be used with the exemplary computing device include, but are not limited to, magnetic tape cassettes, flash memory cards, solid state storage devices (SSDs), digital versatile disks, digital video tape, solid state RAM, solid state ROM, and the like. The hard disk storage devices 141, 146 and 147, or any of these other removable/non-removable, volatile/nonvolatile computer storage media, are typically connected, either directly or indirectly, to the system bus 121 through a memory interface such as interface 140. In the illustrated exemplary computing device 100 of FIG. 1, the hard disk storage device 141 is shown as being directly connected to the non-volatile memory interface 140, such as through a physical connection internal to the computing device 100, or an external connection exposed via a port, while the hard disk storage devices 146 and 147 are shown as being connected to a storage host controller 145, such as, for example, a Redundant Array of Inexpensive Devices (RAID) controller which can then, in turn, be connected to the interface 140, again such as through an connection physically internal to the computing device 100. The non-volatile memory interface 140 can be any non-volatile memory interface, including, but not limited to, a Universal Serial Bus (USB) interface, an interface conforming to any one or more of the IEEE1394 specifications, a Serial AT Attachment (SATA) interface, or other like interfaces.

The computing device 100 may operate in a networked environment using logical connections to one or more remote computers. For simplicity of illustration, the computing device 100 is shown in FIG. 1 to be connected to a network 155 that is not limited to any particular network or networking protocols. The logical connection depicted in FIG. 1 is a general network connection 151 that can be a local area network (LAN), a wide area network (WAN) or other network. The computing device 100 is connected to the general network connection 151 through a network interface or adapter 150 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 151. It will be appreciated that the network connections shown are exemplary and other means of establishing a communications link between computing devices may be used.

Turning to the storage system 160, the storage system can be used in the same manner as, and can replace or act as any of the hard disk storage devices 141, 146 and 147 described above. Additionally, the storage device 210 of the storage system 160 can be a hard disk drive, or it can be any storage device utilizing any of the above described storage media. As shown in the exemplary storage system 160, the storage device 210 can comprise one or more computer-readable media 190, and such computer-readable media can comprise non-removable, nonvolatile magnetic media, such as in the case of the hard disk storage devices 141, 146 and 147, or it can comprise other removable/non-removable, volatile/nonvolatile computer storage media, such as magnetic tape cassettes, flash memory cards, solid state storage devices (SSDs), digital versatile disks, digital video tape, solid state RAM, solid state ROM, and the like.

The computer-readable media 190 of the storage device 210 of the storage system 160 can be utilized by the computing device 100 to store computer readable instructions, data structures, program modules and other data for the computing device 100. For example, computer-readable media 190 of the storage device 210 is illustrated as storing encrypted data 195, which can be data that, when decrypted by the storage device 210, provides the basis for some or all of the operating system 134, other program modules 135 or program data 136.

In addition to the computer-readable media 190, the exemplary storage device 210 of the storage system 160 can also comprise a hardware cryptographic system 180 that can encrypt data provided to the storage system 160 for storage on the computer-readable media 190 and can decrypt data read from the computer-readable media that will, then, be provided to the computing device 100. As such, the hardware cryptographic system 180 can perform its cryptographic functions without burdening the CPU 120 or other elements of the computing device 100, which can, in one embodiment, treat the storage system 160 in the same manner as any other storage device, without regard to data encryption and decryption.

The hardware cryptographic system 180 of the storage device 210, in order to perform the cryptographic functions referenced above, can comprise one or more processing units 181 and instructions 183 for performing cryptographic functions, such as the encryption of data provided to the storage system 160 and the decryption of data read from the computer-readable media 190. The hardware cryptographic system 180 can also comprise a bus 182, such as the bus 121, described in detail above, that can link the processing units 181 to the storage media or memory that can comprise the instructions 183.

Of relevance to the descriptions below, the storage system 160 can further comprise a key device 170 that can comprise cryptographic information 175. The cryptographic information 175 of the key device 170 can be referenced by, and can inform the encryption and decryption performed by, the hardware cryptographic system 180 of the storage device 210. In one embodiment, as will be described further below, the hardware cryptographic system 180 can perform its cryptographic functions with reference to both the cryptographic information 175 of the key device 170, and additional cryptographic information provided by, for example, the full volume encryption service 137. The full volume encryption service 137 can provide a logical key that can be stored on the computer-readable media 190 and can be referenced by, and utilized by, the hardware cryptographic system 180.

The key device 170 is a physical entity that is physically separable, and communicationally separable, from the storage device 210. The dashed line around the storage system 160 is meant to signify that the storage system 160 may not necessarily be a single physical construct. In particular, the term “storage system”, as utilized here and in the descriptions below, is intended to include both the key device 170 and the storage device 210, even if such components are not physically co-located within a single physical container or other physical construct.

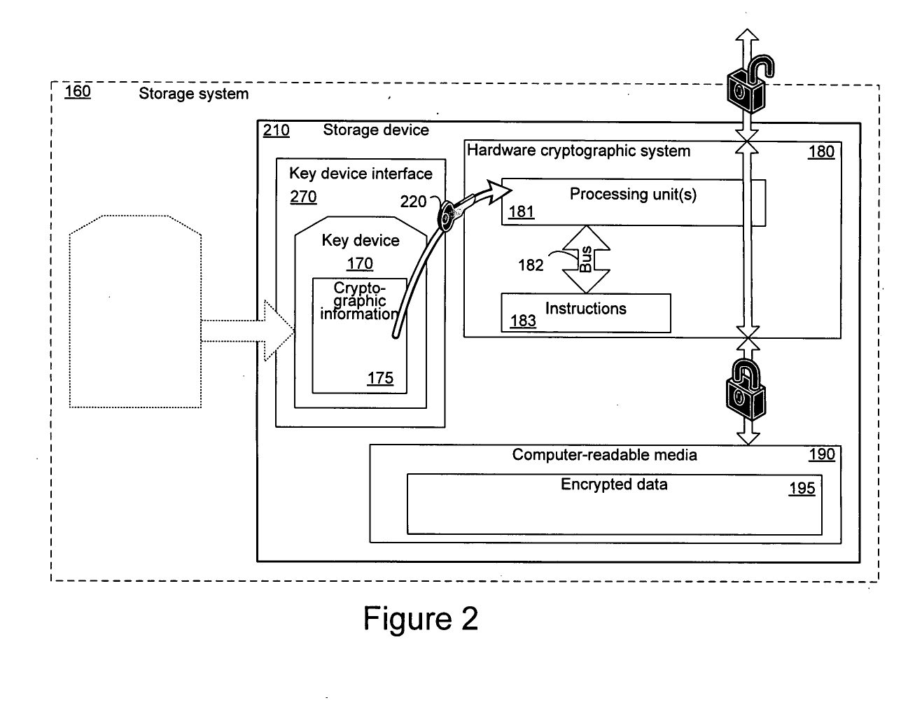

Turning to FIG. 2(the few paragraphs above refer to FIG. 2, is that ok?), one exemplary operation of the storage system 160, with the physically and communicationally removable key device 170, is shown. As illustrated, the storage device 210 can, in the illustrated embodiment, comprise not only the previously described hardware cryptographic system 180 and the computer-readable media 190, but can also comprise a key device interface 270. In one embodiment, the key device interface 270 can be a slot or connector on the storage device 210, such that the key device 170 could be physically inserted into the key device interface 270, or otherwise connected to it, such that, when inserted or connected, the key device 170 did not substantially alter the dimensions of the storage device 210. In such a case, the storage device 210 can be utilized by a computing device, such as the computing device 100, described in detail above, as would any other similar storage device. For example, if the storage device 210 was designed to conform to a standard hard disk drive size, then the computing device 100 could utilize the storage system 160, comprising both the storage device 210 and the key device 170 physically connected thereto, as an internal hard disk drive, and the presence, or absence, of the key device, would not alter the physical dimensions of the storage device 210 to inhibit such a use.

In another embodiment, the key device 170 can take the form of a Global System for Mobile (GSM) communications Subscriber Identity Module (SIM) such as is commonly utilized for cellular telephones. In such a case, the key device interface 270 can be a GSM SIM interface, again as typically included within a cellular telephone. Such an embodiment can offer a cost advantage because both the physical form factor of the key device 170 and the key device interface 270 can be commonly utilized and, consequently, inexpensive.

If the key device 170 is in the form of a GSM SIM card, certain properties of traditional GSM SIM cards can be leveraged. For example, the SIM Serial Number (SSN) commonly stored on a GSM SIM card can be utilized to identify the key device 170. More specifically, a typical SSN comprises 19 digits arranged as a two digit telecom identifier, followed by a two digit country code, followed by a two digit network code, followed by four digits representing the month and year of the manufacture of the GSM SIM, followed by two digits referencing a switch configuration code, followed by six digits referencing the SIM number, followed by a final single check digit. In the case of a key device 170 in the form of a GSM SIM card, the first four digits could be assigned zeros, as could the two digits referencing the switch configuration, but the remaining digits could be utilized in an analogous manner.

Additionally, in an embodiment where the key device 170 is in the form of a GSM SIM card, an Integrated Circuit Card IDentifier (ICCID) can be used to store a unique identification of the storage device physical container 210 with which the key device 170 is associated. As will be described in further detail below, such an ICCID, along with other visual, physical markings on a key device 170 can be utilized as proof of the destruction of the encrypted data 195 that was encrypted with reference to the cryptographic information 175.

Since existing GSM SIM cards, and their respective protocols, may not be designed to provide the cryptographic information 175 to the hardware cryptographic system 180, a new function can be added to the traditional GSM SIM card protocols, such as the ISO7816 protocol, which enables the hardware cryptographic system 180 to pass data to the key device 170 to be signed by the cryptographic information 175. Such a function can be one mechanism by which the encrypted data 195 is rendered inaccessible unless the key device 170 is communicationally coupled to the hardware cryptographic system 180.

In another embodiment, the key device 170 can comprise a common connector, such as a Universal Serial Bus (USB) connector as can, likewise, the corresponding key device interface 270. As with the GSM SIM embodiment described above, a USB connector likewise provides cost advantages due to its ubiquity. In such an embodiment, the below described communications between the key device 170 and the hardware cryptographic system 180 can be performed via the well-known USB communication protocol.

Because the storage system 160 can be utilized as any other storage device, the key device interface 270 can be oriented or positioned, within the storage device 210, such that easy visual inspection of the key device interface 270, to verify the presence or absence of the key device 170, could be accomplished. For example, if the storage device 210 was a hard disk drive, the key device interface 270 could be positioned along the periphery of the storage device that is typically visible once the storage device is installed. In such a case, if the storage device 210 was installed with numerous other storage devices, such as in a rack-mounted system appropriate for server computing devices, visual inspection of the key device interface 270 could be accomplished without removing the storage device 210 from the rack. Alternatively, the storage device 210 could further comprise a transparent portion, or a physically absent portion, such that visual verification of the presence or absence of the key device 170 in the key device interface 270 could be accomplished, again without requiring removal of the storage device 210 from its physical connection to, for example, the computing device 100.

In another embodiment, the key device interface 270 can be communicationally connected to visual signaling mechanisms, such as Light Emitting Diodes (LEDs) that can signal when a key device, such as the key device 170, is physically connected to the key device interface 270. The visual signaling mechanisms can further be controlled by the processing units 181 of the hardware cryptographic system 180. For example, if the processing units 181 determine that the cryptographic information 175 is inappropriate or invalid given the encrypted data 195 stored on the computer-readable media 190, the visual signaling mechanism can be instructed to generate an appropriate signal, such as a red signal or a blinking signal, thereby notifying a user that the user may have inserted an incorrect key device 170.

As shown in FIG. 2, the key device 170 can, initially, be physically separate from the storage device 210. In one embodiment, such a physical separation between the key device 170 and the storage device 210 can also result in the communicational separation of the key device 170 and the storage device 210. Without access to the cryptographic information 175 of the key device 170, the hardware cryptographic system 180 can be unable to decrypt any of the data stored on the computer-readable media that was encrypted with reference to the cryptographic information 175.

Subsequently, the key device 170 can be physically inserted into, or otherwise attached or connected to, the key device interface 270. Such a physical connection can further enable a communicational connection between the key device 170 and the storage device 210. The enabled communicational connection can allow the processing units 181 of the hardware cryptographic system 180 to retrieve, or otherwise obtain, from the cryptographic information 175, information relevant to the decryption of the previously encrypted data stored on the computer-readable media 190. In one embodiment, the cryptographic information 175 can comprise a “physical key” 220, which can be a series of bits that can be utilized as a key for encryption and decryption operations in manners well known to those skilled in the art. The term “physical key”, therefore, as utilized in the descriptions below, is intended to refer to a collection of data utilized as a cryptographic key that is provided from, and is stored on, a physically removable source, such as the key device 170. Such a physical key 220, is meant to be in contrast to a “logical key”, which is not physically separable from the media on which the data encrypted with such a key is stored.

The key device 170 does not, necessarily, need to be physically connected to the storage device 210 to be communicationally connected to the storage device. The above described embodiment provides for a physical connection between the key device 170 and the storage device 210 to avoid sending any of the cryptographic information 175 over the storage device's common type interface. In such a manner, the hardware design of the key device 170 and the storage device 210 can ensure that the cryptographic information 175 cannot be obtained by an external entity and, as such, a physical destruction of the key device 170, as described in further detail below, can serve as proof of the unavailability of the cryptographic information 175, since such information could not have been copied off of the key device 170 and retained elsewhere.

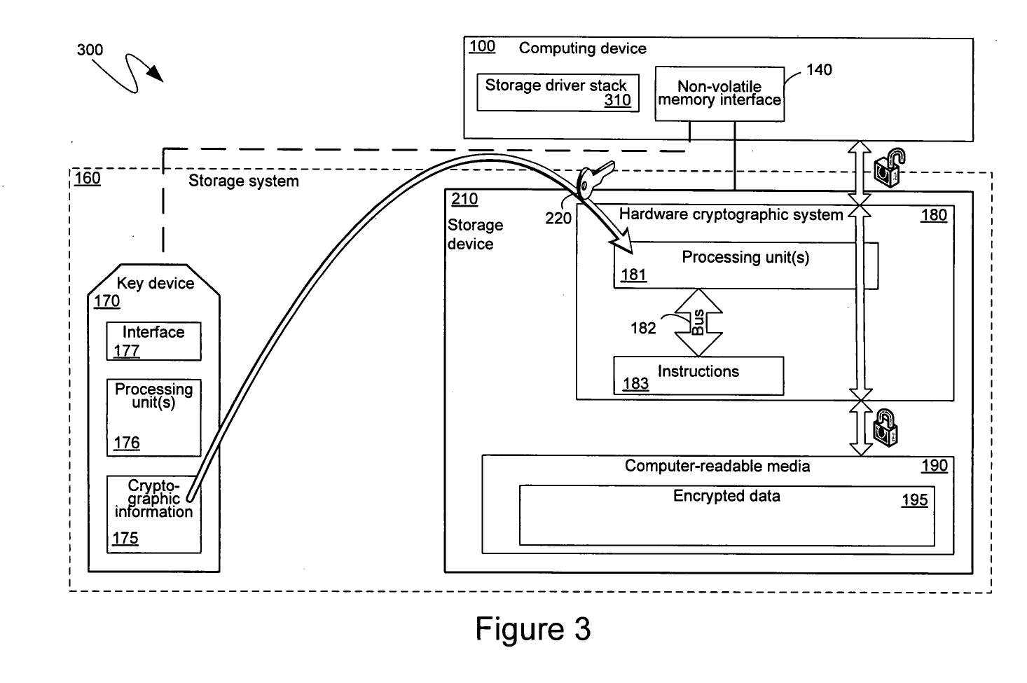

In an alternative embodiment, however, the cryptographic information can be secured despite the transfer of at least some of the cryptographic information 175 over external communicational interfaces of the storage device 210. Turning to FIG. 3, a system 300 is shown, illustrating a communicational connection between the key device 170 and the storage device 210 via the computing device 100, despite a physical separation of the key device 170 and the storage device 210. As shown, the system 300 can comprise the computing device 100 and the storage system 160, which, in turn, comprises the key device 170 and the storage device 210. In one embodiment, both the key device 170 and the storage device 210 can be independently connected to the computing device, though, as shown, the connection of the key device 170 to the computing device 100 can be optional and the key device 170 can communicate with the computing device 100 through other connections, such as a connection to the storage device 210. For example, in the one embodiment, the storage device 210 can be connected internally to the computing device 100, such as in the form of, for example, an internal hard disk drive. The key device 170, in turn, can be connected to an external interface of the computing device 100, such as a popular peripheral or storage interface, including both wired and wireless interfaces. In such a manner, the key device 170 can be communicationally separated from the other elements of the storage device 160 without requiring physical access to the storage device 210.

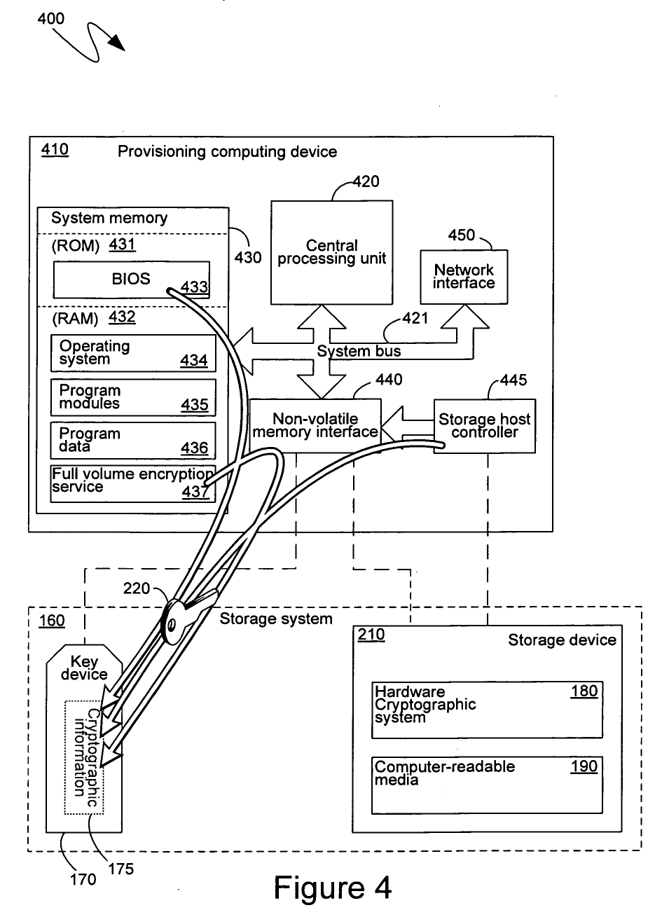

The key device 170, although not specifically illustrated in other Figures for simplicity of illustration and presentation, can, optionally, comprise elements in addition to the cryptographic information 175. For example, as will be described further below, the key device 170 can comprise a module analogous to a Trusted Platform Module (TPM). In FIG. 3, optional elements including one or more processing units 176 and one or more interfaces 177 are shown for purposes of describing the optional independent connection between the key device 170 and the computing device 100. Specifically, the interface 177 can be the same type of interface as the interface 140 described above, to enable a physical or wireless communicational connection between the computing device 100 and the key device 170. Similarly, the one or more processing units 176 can comprise processing units that can establish and maintain communications between the key device 170 and the computing device 100, such as via communicational protocols appropriate for the interfaces 140 and 177. References within the present description to a key device 170, therefore, are meant to include, as optional components, the interface 177 and processing units 176 to enable the key device 170 to independently communicate with, for example, the computing device 100, and to perform the steps described below as performed by the key device 170, including, but not limited to, the steps described below with reference to FIGS. 4, 5 and 8.

In addition, a storage driver stack 310, such as can be, for example, part of the operating system 134, or even the BIOS 133, can recognize the connection of the key device 170 and the storage device 210 to the interfaces of the computing device 100, such as the interface 140. Upon detecting the connection of both the key device 170 and the storage device 210, the storage driver stack 310 can enable secure communication between them. For example, communication between the key device 170 and the storage device 210 can be secured by rendering such communications inaccessible to higher level software, such as other elements of the operating system 134 or the program modules 135.

In another embodiment, the instructions 183 can comprise instructions for establishing a connection between the hardware cryptographic system 180 and the key device 170 through communicational pathways of the computing device 100. For example, the instructions 183 can comprise instructions that look for, and establish communication with, the key device 170 when the key device is recognized by the computing device 100 as a connected peripheral. To maintain security, such communications can be encrypted or other anti-malware measures can be implemented. For example, the key device may present itself to the computing device 100 as a non-storage peripheral device, to prevent malware that may be executing on the computing device 100 from attempting to read the cryptographic information 175 from the key device 170.

In an alternative embodiment, the key device 170 can comprise the capability for establishing communication with the storage device 210, that can be communicationally connected to the same computing device 100. For example, the key device can look for specific storage device identifiers when it is communicationally connected to the computing device 100. Again, security measures can be implemented to prevent malware that may be executing on the computing device 100, from interfering with, or intercepting, communications between the key device 170 and the storage device 210.

Once communications are established between the key device 170 and the hardware cryptographic system 180, the physical key 220 or other cryptographic information 175 can be accessed from the key device 170 by the processing units 181, or can be provided by the key device to the processing units, to enable the processing units to decrypt data previously stored on the computer-readable media 190 and to encrypt new data provided by the computing device 100 for storage on the computer-readable media 190. In one embodiment, the key device 170 can provide the physical key 220, or other cryptographic information 175, to the processing units 181 only after the processing units 181, or some or all of the other components of the storage device physical container 210 have authenticated themselves to the key device 170. For example, a “trusted” key device (TKD) can comprise a module analogous to a Trusted Platform Module (TPM) found on some computing devices, along with the other elements of the key device 170 that has described in detail above. Such a TKD could measure some or all of the components of the storage device 210 by, for example, obtaining unique values from such components and then hashing and combining those values in a manner known to those of skill in the art. The resulting measurements can uniquely identify the storage device 210, and the physical key 220, or other cryptographic information 175, can be sealed by this TKD to those measurements such that, again in a manner known to those skilled in the art, the physical key or other cryptographic information may not be released by the TKD to the processing units 181 unless the storage device 210, to which the TKD is communicationally coupled, is found by the TKD to have the same measurement as that used to seal the physical key or other cryptographic information. In such a manner, the TKD can prevent the release of the physical key 220, or other cryptographic information 175, to a device that is merely “spoofing” the storage device 210 in an effort to obtain the physical key or cryptographic information of the TKD.

The cryptographic information 175 of the key device 170 can be stored on the key device 170 when the key device is manufactured. In one embodiment, multiple sets of, for example, physical keys 220, can be stored as the cryptographic information 175, and each subsequent storage device's hardware cryptographic system 180 that communicates with the key device 170 can acquire the next physical key 220 and mark it as in use, thereby enabling the next storage device's hardware cryptographic system 180 to be able to appropriately select the next physical key 220. In such a manner, a single key device 170 can be shared by multiple storage devices. Thus, for example, if the computing device 100 was communicationally connected to multiple storage devices, such as in a RAID system, or if the computing device 100 was acting as a server computing device, then a single key device 170 could provide appropriate cryptographic information 175 to each of those storage devices.

In an alternative embodiment, the cryptographic information 175 of the key device 170 can be provided by the storage device 210 itself. Specifically, if the key device 170 is communicationally coupled to the storage device 210, such as, for example, in the manner described above, but the key device 170 does not comprise any cryptographic information 175, the hardware cryptographic system 180 of the storage device 210 can generate the cryptographic information 175 and provide it to the key device 170. The encryption and decryption of the data 195 stored on the computer-readable media 190 of the storage device 210 can then proceed in the manner described in detail below.

In another alternative embodiment, however, the cryptographic information 175 of the key device 170 can be provided to the key device 170 by a provisioning computing device that can either be the same computing device that is utilizing the storage system 160 to store and retrieve data, or it can be a different computing device. Turning to FIG. 4, a system 400 is shown comprising a provisioning computing device 410 and the storage system 160. As indicated, the provisioning storage device 410 can be the same as the computing device 100, described above, or it can be a different computing device. For ease of reference and illustration, therefore, the elements of the provisioning computing device 410 are numbered differently from analogous elements of the computing device 100, though their functions may be similar, or even identical. The CPU 420, system bus 421, system memory 430, non-volatile memory interface 440 and the storage host controller 445 are all, therefore, similar to the previously described CPU 120, system bus 121, system memory 130, interface 140, and storage host controller 145. Similarly, the ROM 431, with the BIOS 433, and the RAM 432, with the operating system 434, program modules 435, program data 436 and full volume encryption service 437 are, also, analogous to the above described ROM 131, BIOS 133, RAM 132, operating system 134, program modules 135, program data 136 and full volume encryption service 137.

In one embodiment, the key device 170 can be communicationally connected to the provisioning computing device 410, such as directly through the non-volatile memory interface 440, or indirectly through the storage device 210, which can, itself, be connected directly to the interface 440, or the storage host controller 445. If the key device is independently connected to the provisioning computing device 410, then the storage device 210 can, optionally, be connected to the provisioning computing device 410 as well, such as through the controller 445 or the interface 440. Optional connections, as before, are illustrated in FIG. 4 via dashed lines. Once the key device 170 and the provisioning computing device 410 are communicationally coupled to one another, the provisioning computing device 410 can then provide cryptographic information 175 to the key device 170, such as in the form of the physical key 220. The cryptographic information 175 of FIG. 4 is illustrated as grayed-out to indicate that it is not, at least in part, present on the key device 170 until provided by the provisioning computing device 410.

The cryptographic information 175 provided to the key device 170 by the provisioning computing device 410 can be provided by any one of multiple sub-systems of the provisioning computing device 410. For example, in addition to utilizing a logical key, the full volume encryption service 437 can leverage its existing functionality to generate a physical key 220 and provide it to the key device 170. Alternatively, the physical key 220 can be generated by dedicated hardware, such as hardware that can be present in a storage host controller 445 or other storage interface. As yet another alternative, the physical key 220 can be provided to the key device 170 via the BIOS 433.

To maintain the security and secrecy of the physical key 220, or any other cryptographic information 175 provided to the key device 170, such information can be provided by the provisioning computing device 410 in a manner that minimizes the potential for such information to be obtained by adversarial parties, such as through malicious computer-executable instructions executing on the provisioning computing device 410. Therefore, in one embodiment, the physical key 220, or any other cryptographic information 175 provided to the key device 170, can be provided prior to the completion of the booting of the provisioning computing device 410, and the provided information can be deleted from the provisioning computing device also prior to the completion of the booting of the provisioning computing device. Because malicious computer-executable instructions typically cannot operate prior to the completion of the booting of the host computing device, by providing, and then discarding, information to the key device 170 prior to the completion of the booting of the provisioning computing device 410, the provided information can be protected from any malicious computer-executable instructions that may subsequently execute on the provisioning computing device.

For example, the BIOS 433 can detect the presence of the key device 170 communicationally connected to an interface of the provisioning computing device 410, and can provide the physical key 220 to the key device 170 prior to initiating any other processing on the provisioning computing device, including, for example the initiating of the execution of the operating system 434. Similarly, the controller 445 can detect the presence of the key device 170 when then RAID controller is first initialized and prior to, at least the completion, if not the commencement of, the booting of the operating system 434. The RAID controller 445 can then, likewise, provide the physical key 220 to the key device 170, and can discard such a physical key, before any malicious computer-executable instructions can execute on the provisioning computing device 410. As another alternative, the full volume encryption service 437, since it likely already comprises mechanisms that are designed to protect its logical keys from malicious computer-executable instructions executing on the provisioning computing device 410, can utilize those mechanisms to securely provide the physical key 220 to the key device 170 and then discard the physical key to further reduce the possibility that the physical key will be discovered on the provisioning computing device 410. Once the cryptographic information 175, including, for example, the physical key 220, is provided to the key device 170 by the provisioning computing device 410, the key device 170 can be communicationally and, optionally, physically disconnected from the provisioning computing device 410 and can then be utilized, as described above, in conjunction with the storage device physical container 210 to enable the storage device 160 to store encrypted data and access encrypted data already stored on the computer-readable media 190.

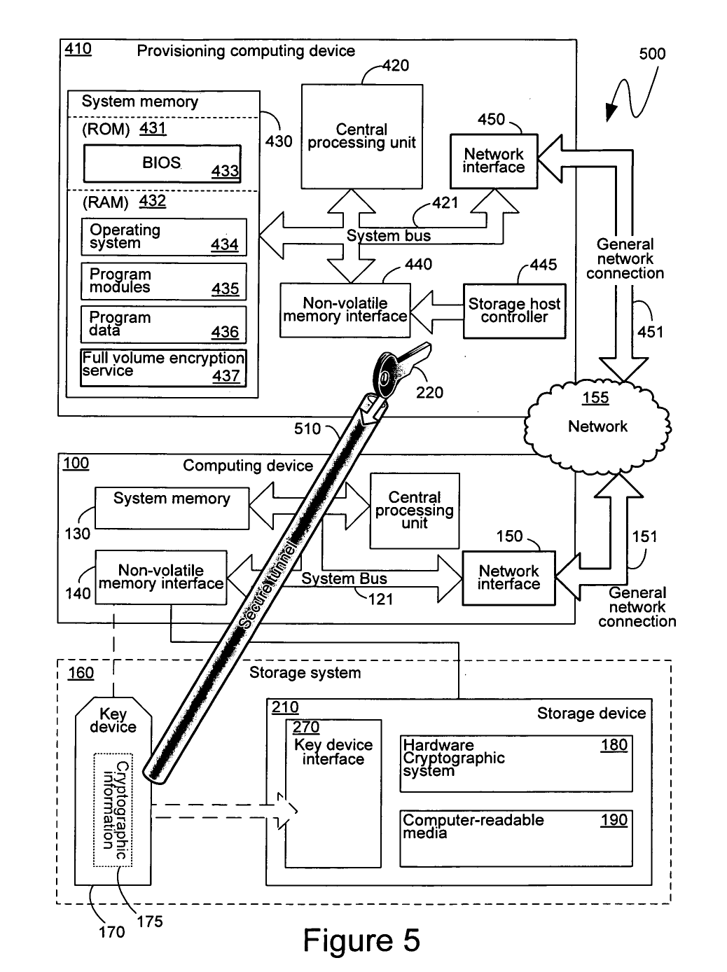

Rather than provisioning a key device 170 that is physically connected to the provisioning computing device 410 itself, such as the key device 170 illustrated in the system 400 of FIG. 4, in another embodiment, the key device 170 can be provisioned by a provisioning computing device 410 while it is communicationally connected to another computing device, such as, for example, if the key device 170 was physically inserted into the key device interface 270 of the storage device 210, and the storage device 210 was then installed into a computing device 100. Turning to FIG. 5, a system 500 is shown comprising the storage system 160 communicationally coupled to, and being utilized by, a computing device 100 which is, in turn, communicationally coupled to a provisioning computing device 410. As illustrated by the dashed line connecting the key device 170 to the non-volatile memory interface 140, the key device can be optionally connected to the storage device 210, such as through a key device interface 270, as described above, or it can be connected to the non-volatile memory interface 140 and communications between the key device and the other components of the storage device 210 can be through the computing device 100.

In one embodiment, when initially connected to the computing device 100, the storage device 210 may not be capable of utilizing the cryptographic information 175 of the key device 170 because such information, as illustrated by the graying out of the cryptographic information in FIG. 5, may not yet have been provided. To obtain, at least a part of, the cryptographic information 175, the key device 170 can establish a secure communication tunnel 510 to a provisioning computing device 410. In one embodiment, the key device 170 can comprise mechanisms that can request access to the network interface of a computing device to which the key device 170 and the storage device 160 are connected, such as, for example, the network interface 150 of the storage device 100. Once the key device 170 has access to the network interface 150, it can establish a communicational connection, such as through the network 155, to the provisioning computing device 410. In one embodiment, to simplify the mechanisms of the key device 170, since the key device 170 may have limited capabilities due to, for example, cost considerations, the network address of a provisioning computing device 410 can be preselected such that any computing device that sought to be a provisioning computing device would be assigned such a preselected address. In an alternative embodiment, however, the key device 170 can comprise mechanisms that can search for the provisioning computing device 410 on the network 155 via more advanced methodologies.

Once the key device 170 has established a communicational connection with the provisioning computing device 410, such as through the network 155, it can proceed to establish a secure communication tunnel 510 through standard tunneling mechanisms, such as the Point-to-Point Tunneling Protocol (PPTP) or the Level 2 Tunneling Protocol (L2TP). As will be known by those skilled in the art, such tunneling mechanisms can rely on the exchange of various security credentials, such as shared passwords or keys, or they can rely on security credentials provided by an independent verifier, such as a Kerberos or RADIUS server. To the extent required to establish the secure tunnel 510, the key device 170 can comprise the necessary passwords, keys or other authentication mechanisms or information to enable it to establish the secure tunnel 510.

Once the secure communication tunnel 510 has been established between a provisioning computing device 410 and the key device 170, the provisioning computing device 410 can provision some or all of the cryptographic information 175 on the key device 170, such as in the manner described above. Thus, as illustrated in FIG. 5 by the thicker borders, the provisioning of a key device 170 by a provisioning computing device 410 through the secure tunnel 510 can occur via the BIOS 433, storage host controller 445, full volume encryption service 437, or other component on the provisioning computing device 410, and can then be communicated via the network interface 450 and the general network connection 451, through the network 155 and the general network connection 151 to the network interface 150 of the computing device 100 to which the key device, and the storage device 210 are communicationally, and possibly physically, connected.

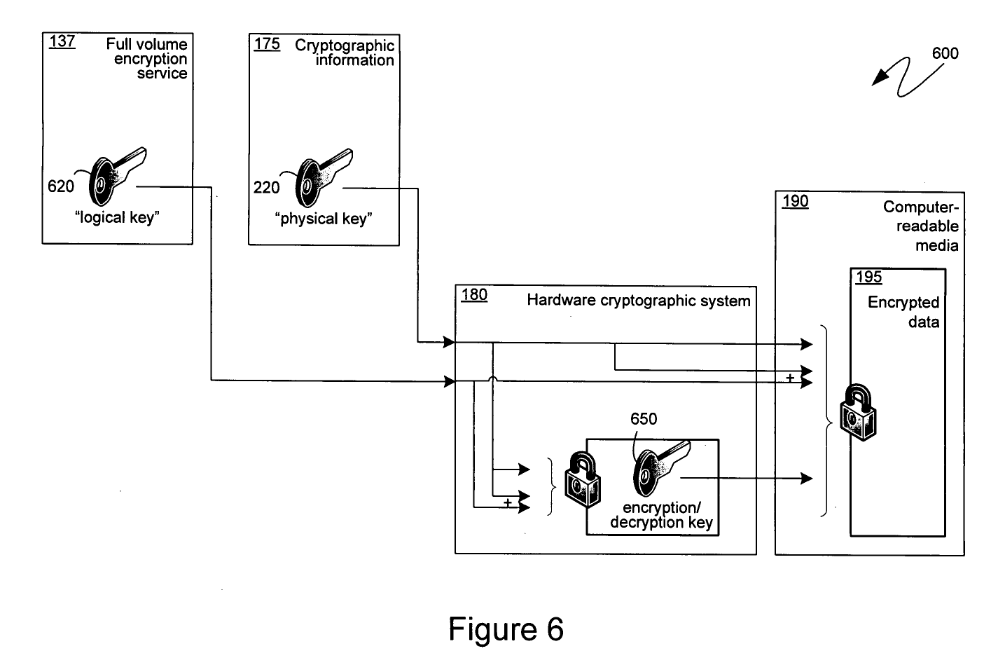

The cryptographic information 175 of the key device 170 can be utilized by the hardware cryptographic system 180 to both encrypt data provided to the storage device 160 by the computing device 100 for storage on the computer-readable media 190 of the storage device, and to decrypt data already stored on the computer-readable media 190 prior to the provision of such data, by the storage device 160 to the computing device 100. Turning to FIG. 6, the system 600 illustrates several exemplary mechanisms by which the hardware cryptographic system 180 can utilize or reference the cryptographic information 175 of the key device 170. For example, as shown, the physical key 220 of the cryptographic information 175 can be utilized by the hardware cryptographic system 180 to encrypt or decrypt the data 195 on the computer-readable media 190. In an alternative embodiment, also illustrated, the physical key 220 obtained from the cryptographic information 175 of key device 170 can be combined with the logical key 620, such as would be generated and utilized by the full volume encryption service 137. For example, if each of the logical key 620 and the physical key 220 comprised a 128-bit key, a combination key of 256 bits could be generated by simply concatenating the two 128-bit keys together. Such a 256-bit key could then be utilized by the hardware cryptographic system 180 to encrypt and decrypt the data 195 stored on the computer-readable media. Of course, other combinations of the logical key 620 and the physical key 220 could also be implemented by the hardware cryptographic system 180.

Traditionally, the encryption and decryption of data, such as data 195, comprises multiple layers of keys. For example, the key utilized to encrypt and decrypt the data 195 can itself be encrypted by another key such that if the key used to encrypt the ultimate encryption and decryption key was lost, a new key could be generated and, since the ultimate encryption and decryption key has not changed, the data 195 does not need to be reencrypted Such a penultimate key can, then, itself be encrypted by yet another downstream key to provide additional efficiency in specific circumstances. To illustrate the presence of such multiple layers of keys, the system 600 of FIG. 6 illustrates an encryption/decryption key 650 that can be utilized by the hardware cryptographic system 180 to encrypt and decrypt the data 195 stored on the computer-readable media 190. The encryption/decryption key 650 can be decrypted by the physical key 220 or a combination of the logical key 620 and the physical key 220, rather than utilizing the physical key 220 directly to decrypt the data 195. As indicated, additional such key layers are also contemplated, though they are not shown to maintain simplicity of illustration.

Multiple layers of keys can likewise be utilized to implement the above-described provisioning of at least some of the cryptographic information 175 of the key device 170 by a provisioning computing device 410. More specifically, rather than providing at least a portion of the cryptographic information 175 directly to the key device 170, the provisioning computing device 410 could instead provide such information to the storage device 210. The storage device 210 could then encrypt such received information with an internal key and the resulting cryptographic information could be provided to the key device 170 and utilized to encrypt and decrypt the data 195 on the storage media 190. Such an embodiment would prevent the transmission, over external interfaces, of the cryptographic information that is ultimately utilized to encrypt and decrypt the data 195 on the storage media 190.

Because all, or substantially all, of the data 195 on the computer-readable media 190 can be encrypted by the hardware cryptographic system 180 with reference to the cryptographic information 175, when the cryptographic information 175 is no longer available, such as, for example, when the key device 170 is communicationally, and optionally, physically, disconnected from the hardware cryptographic system, the data 195 previously stored on the computer-readable media becomes no longer accessible. Furthermore, if the key device 170 comprising the cryptographic information 175 was destroyed, such that the cryptographic information 175 was no longer recoverable or readable, the data 195 stored on the computer-readable media would no longer be accessible, since no key could be created with existing mechanisms that could decrypt such data. Consequently, the destruction of the key device 170 can act as a virtual destruction of the data 195 on the computer-readable media 190.

The key device 170, therefore, can be a device that can be efficiently and securely destroyed. For example, the key device 170 can be constructed from material that can be easily shredded or otherwise physically transformed in such a way that the cryptographic information 175 would no longer be recoverable. Alternatively, the key device 170 could be perforated or otherwise structurally weakened along one or more axis such that it could be easily broken and rendered unreadable. Additionally, because the destruction of the key device 170 can be a virtual destruction of the data 195 stored on the computer-readable media 190 that was encrypted with reference to the cryptographic information 175 of the key device 170, the key device 170 can further comprise a visual indicator of the storage device physical container 210 comprising the computer-readable media 190 with which the key device 170 was associated. For example, the key device 170 can have etched or otherwise printed on it a unique identifier of the storage device physical container 210 comprising the computer-readable media 190 with which the key device 170 was associated. Alternatively, as indicated previously, the key device 170, in the form of a GSM SIM card, can have an ICCID that can store the unique identifier of the storage device physical container 210 comprising the computer-readable media 190 with which the key device 170 was associated. Thus, for various certification processes, the virtual destruction of the data 195 on the computer-readable media 190 that was encrypted with reference to the cryptographic information 175 of the key device 170 can be verified by physical or digital inspection of a broken, or otherwise disabled, key device 170.

The secure transport of the data 195 on the computer-readable media 190 can likewise be facilitated by the communicationally, and physically, separable key device 170. For example, if one or more storage devices 210, comprising computer-readable media 190 having encrypted data 195, were to be shipped, the associated key devices 170 could be removed, or otherwise communicationally disconnected from the storage devices, and could be shipped in a separate container or via a separate carrier, or, alternatively, could be held and only shipped after confirmation of the safe receipt of the storage devices was received. If the storage devices 210 were lost or stolen, the data 195 on the computer-readable media of such storage devices would not be accessible without the key devices 170, which would have, presumably, not also been lost or stolen, since they were transported via a different route.

If a different key device is communicationally connected to the storage device 210, the previously encrypted data 195 can be treated by the storage device 210 as free space, thereby virtually deleting such prior data. Alternatively, the hardware cryptographic system 180 can automatically run a secure deletion process, further preventing access to the data 195. As yet another alternative, if a different key device is communicatively connected to the storage device 210, the previously encrypted data can be maintained intact such that subsequent use of the prior key device 170 will allow access to the prior data but not access to any data added while the different key device was communicatively connected to the storage device 210. If no key device 170 is communicationally connected to the storage device 210, the storage device can deny any access requests, other than to allow a connected computing device 100 to issue secure delete commands. However, in one embodiment, if no key device 170 is communicationally connected to the storage device 210, and no such key device 170 was ever previously connected, then the storage device 210 can either utilize cryptographic information generated internally by the hardware cryptographic system 180, or it can report itself as “not ready” to a communicationally coupled computing device 100. In one embodiment, such options can be user- or administrator-selectable. The existence of previously communicationally connected key devices 170 can be maintained by the hardware cryptographic system 180, such as in a log file or similar construct.

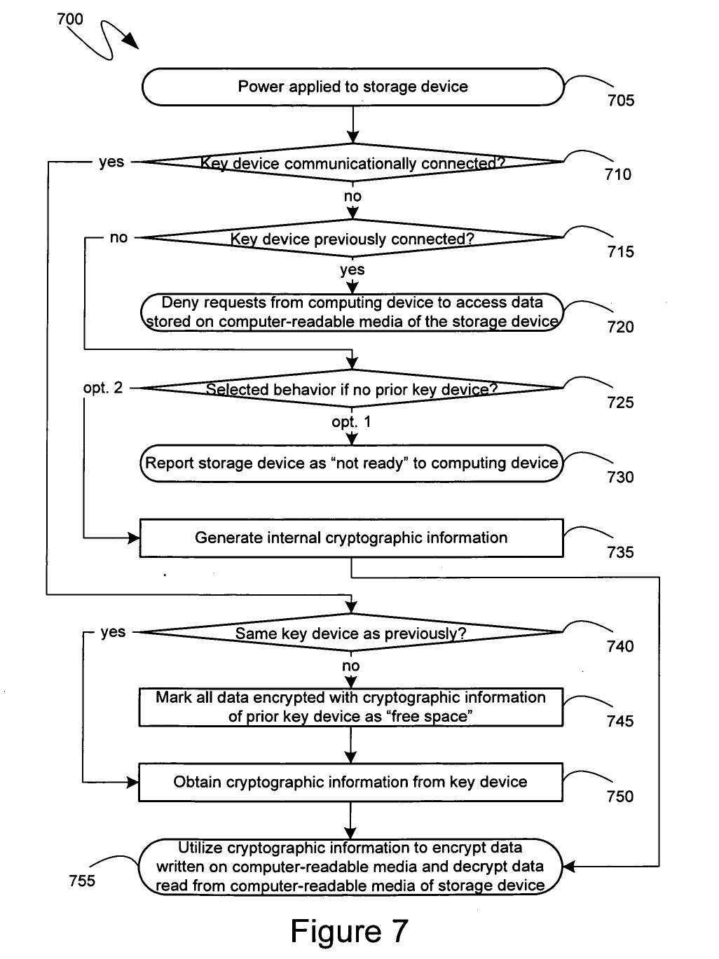

Turning to FIG. 7, a flow diagram 700 illustrates an exemplary series of steps that can be performed by a storage device, such as the above described storage device 210, in determining its behavior depending on the presence or absence of a key device 170. Initially, as indicated by step 705, power can be applied to the storage device. Subsequently, at step 710, a check can be made to determine if a key device 170 is communicationally connected, such as to the hardware cryptographic system 180. The communicationally connected key device 170 can be, optionally, physically connected as well, but the check at step 710 can account for any of the communicational connections described above.

If, at step 710, it is determined that no key device 170 is communicationally connected, a check can be made, at step 715, to determine if a key device 170 was previously connected. For example, as indicated, components of the storage device 210 can maintain a log file, or other construct, that can indicate previously communicationally coupled key devices 170. If, at step 715, it is determined that a key device 170 was previously connected, then processing can end at step 720, where the storage device can deny requests from a communicationally coupled computing device 100, other than requests to securely erase the contents of the computer-readable media 190 of the storage device 210.

If, however, at step 715, it is determined, such as by reference to a log file, that no key device 170 was previously communicationally coupled to the storage device 210, then at step 725 a check can be made as to the selected default behavior in such a case. One option, as indicated by step 730, can be to end processing by reporting the storage device 210 as “not ready” to the communicationally coupled computing device 100. Another option, as indicated by step 735 can be to generate internal cryptographic information which can then be utilized by the hardware cryptographic system 180 to encrypt data being stored on the computer-readable media 190 and decrypt data being read from there. Such a generation of internal cryptographic information can be different from the above-described embodiment wherein the storage device 210 generates the cryptographic information 175 and provides it to the key device 170. In such a case, the generated cryptographic information 175 stored on the key device 170 remains available after the storage device 210 has been powered down or restarted, thereby enabling access to the encrypted data 195 stored on the computer-readable media 190, so long as the key device 170 remains communicationally coupled to the storage device 210. In the present embodiment, the internally generated and utilized cryptographic information is not stored on a key device 170, since, as determined at step 710, no key device is currently communicationally connected. Consequently, data 195 stored in an encrypted manner on the computer-readable media 190 using such internally generated cryptographic information may not be recoverable after the storage device 210 is powered down or restarted, since the cryptographic information used to encrypt the data 195 may no longer be available, as it may have been lost during the power interruption. Such a temporary storage of data may be useful in, for example, a terminal drive when it is desirable to ensure that the files and content on a remote site could not be stolen if the terminal at that remote site were stolen.

Relevant processing can then end at step 755, where the storage device 210 can proceed to utilize the cryptographic information to encrypt and decrypt data as indicated. If, at step 710, a communicationally coupled key device 170 was detected, then processing can proceed to step 740, where a check is made, such as to the log file described previously, to determine if the detected key device 170 is the same key device as was previously communicationally coupled. If the communicationally coupled key device 170 is the same key device as was communicationally coupled previously, then cryptographic information 175 can be obtained from the key device 170 at step 750 and the relevant processing can end at step 755 and the storage device 160 can proceed to utilize the cryptographic information to encrypt and decrypt the data 195 stored on the computer-readable media 190. If, however, it is determined at step 740, that the communicationally coupled key device 170 is not the same key device as was previously communicationally coupled, then at step 745, all of the data 195 that was encrypted with the cryptographic information 175 of the prior key device 170 can be marked as free space on the computer-readable media 190, which, as will be known by those skilled in the art, means that it can be randomly overwritten by new data. Alternatively, as indicated previously, the data 195 that was encrypted with the cryptographic information 175 of the prior key device 170 can be retained such that, if the prior key device 170 were reconnected with the storage device 210, the data 195 would, again, become available to a computing device utilizing the storage system 160. Subsequently, at step 745, the cryptographic information 175 of the currently communicationally coupled key device 170 can be requested and the relevant processing can end at step 755 with the new cryptographic information 175 being utilized to encrypt and decrypt the data, as described.

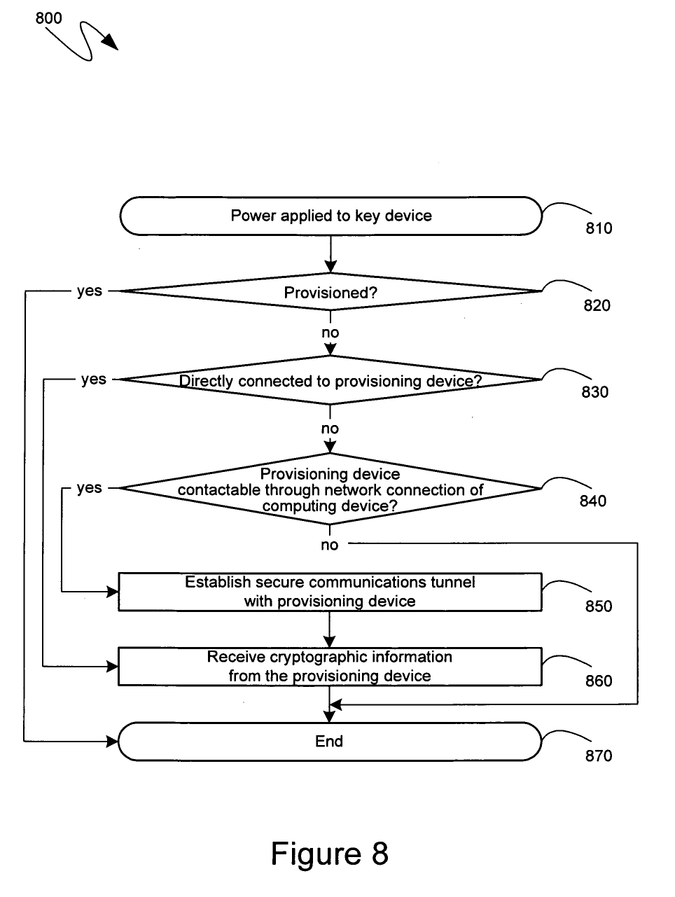

As indicated previously, the key device 170 can, itself, comprise the capability to establish a secure communication tunnel 510 with a provisioning computing device 410. The flow diagram 800 of FIG. 8 illustrates an exemplary series of steps by which the key device 170 can establish such a secure communications tunnel 510. Initially, as shown, power can be applied to the key device 170 at step 810. Subsequently, at step 820, the key device 170 can check to determine if it is already provisioned. For example, a provisioning computing device 410 can provide data to the key device 170 that can cause the key device to attempt to reconnect to the provisioning computing device 410 on a specified interval by, for example, causing the key device 170 to determine, at step 820, that it is not properly provisioned. In one embodiment, if the key device 170 determines that it is properly provisioned, then, at step 870, the relevant processing can end.

If, however, at step 820, the key device 170 determines that it can request provisioning, it can proceed, at step 830, to determine if it is directly connected to a provisioning computing device 410, such as via a physical connection, or a wireless connection directly to the provisioning computing device 410. If the key device 170 is directly connected to the provisioning computing device 410, it can receive cryptographic information 175 from the provisioning computing device at step 860 and, subsequently, the relevant processing can end at step 870. If, at step 830, the key device 170 determines that it is not directly connected to a provisioning computing device 410, it can, at step 840, attempt to contact the provisioning computing device 410 through a network connection of a computing device 100 to which the key device 170 is communicationally coupled, such as in the manner described in detail above. If, at step 840, the key device 170 determines that it cannot find, or otherwise contact, a provisioning computing device 410, the relevant processing can end at step 870. However, if the key device 170 can establish contact with a provisioning computing device 410 through a network connection of the computing device 100 to which the key device 170 is communicationally coupled, then, at step 850, the key device can establish a secure communication tunnel 510, such as in the manner described in detail above. The key device 170 can, thereafter, at step 860, receive the cryptographic information 175 from the provisioning computing device 410 through the established secure tunnel 510 and the relevant processing can, subsequently, end at step 870.

As can be seen from the above descriptions, a storage system comprising a storage device and a communicationally and physically separable key device has been provided. In view of the many possible variations of the subject matter described herein, we claim as our invention all such embodiments as may come within the scope of the following claims and equivalents thereto.

We claim:

1. A storage system for storing and providing computing device data, the storage system comprising:
one or more key devices, that are physically and communicationally separable from a storage device, the one or more key devices comprising cryptographic information; and
the storage device comprising: one or more computer-readable media having data stored thereon; one or more processing units; and instructions, executable by the one or more processing units, for performing steps comprising: securing, with reference to the cryptographic information of a communicationally connected key device, from among the one or more key devices, data to be stored on the one or more computer-readable media; and denying requests, from a computing device, to access data stored on the one or more computer-readable media, if all of the one or more key devices are communicationally separated from the storage device and at least one of the one or more key devices was previously communicationally connected to the storage device.

2. The storage system of claim 1, wherein the instructions for securing with reference to the cryptographic information comprise instructions for securing the data to be stored on the one or more computer-readable media with reference to both the cryptographic information and additional cryptographic information stored on the one or more computer-readable media.

3. The storage system of claim 1, wherein the storage device further comprises instructions, executable by the one or more processing units, for marking as no longer usable data on the one or more computer-readable media that was encrypted with reference to the cryptographic information of a former communicationally connected key device, from among the one or more key devices, if a current communicationally connected key device, from among the one or more key devices, is different from the former communicationally connected key device.

4. The storage system of claim 1, further comprising a selector for selecting one of optional instructions executable by the one or more processing units if one or more key devices currently communicationally connected to the storage device are not equivalent to one or more key devices previously communicationally connected to the storage device, the optional instructions comprising: instructions for reporting, to the computing device, that the storage device is not ready; and instructions for generating internal cryptographic information to be utilized in place of the cryptographic information of the one or more key devices.

5. The storage system of claim 1, wherein the storage device further comprises instructions, executable by the one or more processing units, for sending data to the at least one key device to be signed with reference to the cryptographic information of the at least one key device.

6. The storage system of claim 1, wherein at least some of the cryptographic information is provided to the one or more key devices by a provisioning computing device.

7. The storage system of claim 6, wherein at least one of the one or more key devices comprises one or more key device processing units and instructions, executable by the one or more key device processing units, for establishing a secure communication tunnel with the provisioning computing device.

8. The storage system of claim 6, wherein the cryptographic information is provided by the provisioning computing device during a booting of an operating system of the provisioning computing device; and wherein further the cryptographic information is purged from the provisioning computing device prior to a completion of the booting of the operating system of the provisioning computing device.

9. A storage device, physically and communicationally separable from one or more key devices comprising cryptographic information, the storage device comprising:
one or more computer-readable media having data stored thereon;
one or more processing units; and
instructions, executable by the one or more processing units, for performing steps comprising: securing, with reference to the cryptographic information of a communicationally connected key device, from among the one or more key devices, data to be stored on the one or more computer-readable media; and denying requests, from the computing device, to access data stored on the one or more computer-readable media, if all of the one or more key devices are communicationally separated from the storage device and at least one of the one or more key devices was previously communicationally connected to the storage device.

10. The storage device of claim 9, further comprising a physical interface for the one or more key devices, wherein at least a portion of the physical interface is visible from outside of the storage device, the portion being indicative of presence or absence of one or more key devices coupled to the physical interface.

11. The storage device of claim 9, further comprising a visual indicator, indicating a status of at least one of the one or more key devices.

12. A key device, physically and communicationally separable from a storage device comprising encrypted data received from a computing device, the key device comprising:
at least one communicational interface;
computer-readable media comprising cryptographic information utilized to secure the data of the storage device; and
a visible unique identifier of the storage device.

13. The key device of claim 12, further comprising a measuring and sealing module for performing steps comprising:
obtaining unique values from at least some components of a communicationally connected storage device;
deriving a measurement of the communicationally connected storage device based on the obtained unique values; and
providing the cryptographic information to the communicationally connected storage device if the measurement of the communicationally connected storage device is equivalent to a previously obtained measurement.

14. The key device of claim 12, wherein the communicational interface physically connects to a connector on the storage device.

15. The key device of claim 12, further comprising a structurally weakened portion intersecting at least one of the computer-readable media and the at least one communicational interface, wherein physically breaking the key device along the structurally weakened portion renders the cryptographic information unusable.

16. The key device of claim 12, wherein the computer-readable media further comprises additional cryptographic information utilized by another storage device.

17. The key device of claim 12, further comprising one or more processing units, wherein the computer-readable media further comprises instructions, executable by the one or more processors, for establishing a secure communications tunnel between the key device and a provisioning computing device providing the cryptographic information.

18. The key device of claim 12, wherein the key device is a GSM SIM card.

19. The key device of claim 12, further comprising one or more processing units for securing data received by the key device with reference to the cryptographic information.

20. The key device of claim 12, wherein the key device is a USB-based device.
